(19) United States
(12) Patent Application Publication
(10) Pub. No.: US 2009/0230643 A1
(43) Pub. Date: Sep. 17, 2009

(54) SHOPPING CART

(75) Inventors: Rainer Eckert, Kirchheim/Teck (DE); Jürgen Hämmerle, Günzburg (DE); Günther Nägele, Weissenhorn (DE); Michael Rudolph, Sarstedt (DE)

Correspondence Address: BUCHANAN, INGERSOLL & ROONEY PC, POST OFFICE BOX 1404, ALEXANDRIA, VA, 22313-1404, US

(73) Assignee: Wanzl Metallwarenfabrik GmbH, Leipheim (DE)

(21) Appl. No.: 12/441,059

(22) PCT Filed: Sep. 11, 2007
(86) PCT No.: PCT/EP2007/007909

§ 371 Date: Apr. 10, 2009

(30) Foreign Application Priority Data
Sep. 12, 2006 (DE) 10 2006 043 523.0

(51) Int. Cl. B62D 39/00

(52) U.S. Cl. 280/33.998

(57) ABSTRACT

A stackable shopping trolley, with a chassis, includes wheels, a pushing device and a basket, the basket being formed from various parts, such as the basket sides, a basket base and a flap, wherein the parts of the basket are predominantly made from plastic and said shopping trolley is provided with an antenna. Each trolley has an antenna system with several antennae, each antenna being designed as a transmitting antenna or receiving antenna and each antenna is completely and/or partly enclosed by parts of the basket.

The invention relates to a shopping cart with the characteristics contained in the preamble to the main claim.

A shopping cart of this type is used to transport goods or other objects. Such carts are used particularly in supermarkets.

A shopping cart as described in the French patent application FR 2 799 713 is an example of the state of the art. This shopping cart features a basket with a pushing device, and a flap for stacking carts of identical construction. The basket rests on a chassis and is provided with wheels. The cart is made of plastic. Additional plastic carts are described in the documents WO 96/04161, EP 0 672 568 B1 and EP 0 863 829 B1. Carts of this type feature a basket made of plastic. The chassis is also manufactured predominantly of plastic. Carts of this type are made in one piece or consist of a plurality of elements manufactured by means of an injection molding process.

In addition, a cart is described in European Patent Application EP 0 863 829 B1, which is manufactured from a double-walled plastic material.

There are also carts that feature a partition wall inside the basket. A shopping cart of this type is known, for example, from the International Patent Application WO 2005/085035.

In order to save material, the walls are preferably not formed as a continuous surface but are provided with recesses.

The wheels are mounted on the chassis. It has proven practical to supply individual areas, such as parts of the chassis or the basket for example, with reinforcement.

In addition, the European Patent Application EP 1 583 050 describes a shopping cart that is provided with an antenna, which is used for reading RFID tags. The volume of the cart is detected and at the same time the merchandise, each piece of which is provided with an RFID tag, and/or the adjacent surroundings. A shopping cart of this type is also provided with a display device, which displays the evaluated information from the RFID tags of each piece of merchandise inside the cart and passes this information on for further processing and/or further evaluation, to a central computer. The antenna is provided on the corners of the cart or on the upper edge of the basket.

However, difficulties occur, for example inside a supermarket, when a cart is pushed too close to merchandise that is provided with RFID tags. The antenna might then detect goods that are still on the shelves.

In addition, the number of products detected inside the cart might not be identical with the number products that are actually in the basket.

The object of the invention is therefore to describe a better shopping cart for detecting merchandise provided with RFID tags.

This object is inventively achieved with the specific characteristics of the main claim.

One major advantage is found in the division of the antennas into transmitting antennas and receiving antennas, which improves the accuracy of detection.

By means of the arrangement of the antennas, which are completely or partially enclosed by the various parts of the basket, the antennas on the cart do not get in the way. This also prevents them from being damaged during use.

Furthermore, the installation of the antennas during the manufacturing process results in only insignificant additional cost.

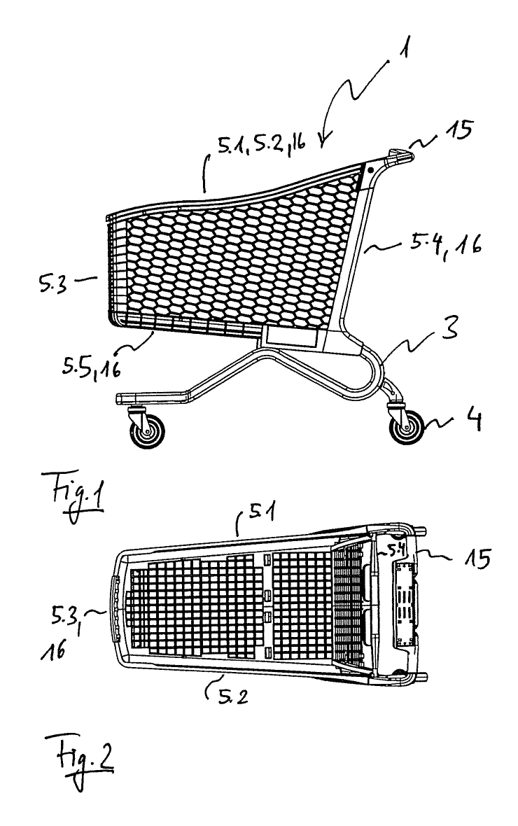

The invention is explained in more detail with an example of an embodiment. This shows:
FIG. 1 a lateral view of a shopping cart
FIG. 2 a top view of the same shopping cart

FIGS. 1 and 2 show a stackable shopping cart 1 with a chassis 3 and with wheels 4. Each chassis 3 carries a basket 5. The basket 5 features various parts: basket side walls 5.1, 5.2, a front basket wall 5.3, a basket base 5.5, and a flap 5.4 are provided, which preferably includes a child seat 5.6 that is not described in more detail. In addition, a pushing device 15 is arranged on the basket 5. Inside the basket 5, a partition wall 5.7, which is not described in more detail, can be provided

The various parts 5.1 to 5.7 of the basket 5 are made predominantly of plastic.

Furthermore, the shopping cart 1 is provided with an antenna system 2a. The antenna system 2a consists of one or a plurality of antennas 2, which are completely and/or partially enclosed by the various parts 5.1 to 5.6 of the basket 5. If a partition wall 5.7 is present, this can also be used for arranging antennas 2.

It has proved advantageous to divide the antennas 2 into transmitting antennas 2.1 and receiving antennas 2.2 within the antenna system 2a. In that way, each antenna 2 of the antenna system 2a is configured either as a transmitting antenna 2.1 or as a receiving antenna 2.2. The number of transmitting antennas 2.1 can be equal to the number of receiving antennas 2.2. A different number of transmitting and receiving antennas 2.1, 2.2, is, however, also conceivable. Transmitting antennas 2.1 and receiving antennas 2.2 are preferably installed separately from each other. The use of a plurality of transmitting and receiving antennas 2.1, 2.2 has so far achieved the best results. It is advisable to integrate the antennas 2.1, 2.2 into the parts 5.1 to 5.7 of the basket 5 at a distance from each other, either completely or in part.

The carts 1 that are meant to be equipped with an antenna system 2a are plastic shopping carts. In order to save material, they are usually not provided with continuous surfaces. The shape and size of the structure 16 is determined by the corresponding injection mold. The various parts 5.1 to 5.7 can also feature different structures 16.

The structure formed in this way can be used for the installation or incorporation of the antennas 2.

When arranging the antennas 2, there area different possibilities. Inside the various parts 5.1 to 5.6, or, as the case may be, inside the partition wall 5.7, a total of one transmitting antenna 2.1 and/or one receiving antenna 2.2 can be installed. However, the use of one transmitting antenna 2.1 and a plurality of receiving antennas 2.2, or one receiving antenna 2.2 and a plurality of transmitting antennas 2.1, are also conceivable. It has been demonstrated that the arrangement of a plurality of transmitting antennas 2.1 and a plurality of receiving antennas 2.2 is advantageous.

It is ultimately a matter for the person skilled in the art to determine what antennas 2 and in what number will be arranged in the various parts 5.1 to 5.6 of the basket 5, or, as the case may be, the partition wall 5.7.

The respective antennas 2.1 to 2.2 are preferably installed in individual circuits and provided with couplings 11, if required. Suitable capacitive and/or inductive components, which align the antennas 2, or, as the case may be, adjust the impedance of a controller 7, are used as a coupling 11, as a component of the antenna system 2a. The controller 7 is a component of the antenna system 2a.

Each antenna 2 is preferably arranged in the form of an antenna circuit. One antenna circuit can be connected directly to another antenna circuit. Antennas 2 can also run one above the other. In this case, the angle is arbitrary, the distance between the two antennas 2 must be chosen so that no interference occurs. The antennas 2.1 and 2.2 can also be arranged parallel to each other or at varying distances to each other.

A copper or aluminum cable is preferably used as antenna 2. Each antenna 2 can be formed as one piece or consist of stamped parts that are easier to process.

The diameter of the transmitting antenna 2.1 is preferably greater than the diameter of the receiving antenna 2.2. Values of 0.5 mm² for the transmitting antenna 2.1 and 0.25 mm² for the receiving antenna 2.2 have proved advantageous. A copper cable is also an obvious option for both types of antenna 2. Aluminum or other conductive materials can also be used as antenna 2.

For better read-out of the RFID tag, the sequence of the individual antennas 2 can be commutated. The sequence changes when the shopping cart 1 moves, for example in combination with a wheel sensor and/or when a product movement is detected. As long as the cart 1 is not moved, the antenna system 2a is in “sleep mode.” In that way, the transmitting power of the transmitting antenna 2.1 can be reduced when it is not in use, and the energy consumption that is required can ultimately be diminished. That results in lower radiated power. When required, the power of the transmitting signal of the transmitting antennas 2.1 is raised, and the sequence of the individual antennas 2 is also changed.

In order to avoid a collision of the individual RFID tags that are applied to the products inside the cart 1, an obvious option is to shut off all of the individual transmitting antennas 2.1, except for one. There is then only one transmitting antenna 2.1 in operation. The transmitting power 2.1 of the transmitting antenna 2.1 that is in operation is then raised in single steps.

The controller 7, as a component of the antenna system 2a, is preferably arranged inside the pushing device 15. But other areas of the cart 1, such as the chassis 3, are also possible. The use of a feed cable 12 has proved advantageous as a connection between the antennas 2 and the controller 7. This cable 12 is in the form of a coaxial cable as an additional component of the antenna system 2a.

A coupling 11 is provided between the coaxial cable and each antenna 2, regardless of whether it is configured as a transmitting or a receiving antenna 2.1, 2.2. This coupling 11 is necessary in order to align each antenna 2, or, as the case may be, to adjust it to the impedance of the controller 7. Here capacitive and/or inductive components suitable for the coupling 11 are placed on a blank provided for this purpose. The capacitive and/or inductive components can be an inductor or a condenser 8.

In a more advanced variant, all antennas 2 are connected to a coupling 11, which is then multi-polar.

It is also possible to provide one coupling 11 for each transmitting antenna 2.1 and each receiving antenna 2.2.

Preferably, a recess 6 for each antenna 2 will already be provided during the manufacturing process of the various components 5.1 to 5.7.

Normally, an injection-die molding process is used for manufacturing the plastic components. A form is manufactured for this. Using this form, the arrangement of the recess 6 in the finished injection molded components 5.1 to 5.7 is determined. The cross section of the recess 6 is left up to the person skilled in the art; a semicircular or rectangular form is the obviously preferred form.

First, the antennas 2.1, 2.2 are placed in this recess 6 in the individual components 5.1 to 5.7. Then they are fixed in place in the recess 6 using fixing means 9. Obvious examples of fixing means 9 are chemical fixations, for example a glue, or a mechanical fixation means using additional components. As protection for the antennas 2.1, 2.2, the recess 6 can preferably be closed using a covering device 10.

There is also the possibility of enclosing the antennas, 2.1, 2.2, partially and/or completely in the various parts 5.1 to 5.7 of the basket 5 during the manufacturing process. In order to do that, the antennas 2.1, 2.2 are placed directly in the mold, fixed in place at the appropriate sites on the mold, and enclosed by material during the injection molding process. This has the advantage of making it possible to dispense with both the recesses 6 in the mold and the fixing means 9 and/or the covering devices 10.

If the chassis 3 is made of a material other than plastic, the antennas 2 are to be arranged, if required, at the appropriate distance to the chassis 3, in order to avoid interference. This should be noted particularly when the chassis 3 to receive the basket 5 is molded in one piece up to the pushing device 15.

The data on each individual product that is received by the receiving antenna 2.2 is passed on by the controller 7 via the transmitting antennas 2.1 to an additional processing unit 13. The data is shown on a display device 14, such as a display, a monitor, etc. The processing unit 13 provides the possibility of evaluating the data according to many different criteria.

The data from each transmitting antenna 2.1 is transmitted by means of WLAN, Bluetooth, etc. to the processing unit 13.

The processing unit 13 and the display device 14 can be arranged directly on the shopping cart 1, in the checkout area of the supermarket or in another location.

If the processing unit 13 is provided on the cart 1, arranging it in the pushing device 15 is an obvious option.

The display 14 is also provided inside or on the pushing device 15, said display showing the data on the goods in the cart 1.

A supply of electricity must be ensured for each cart 1. This is preferably done by means of a battery that is arranged in a fixed position on the cart 1. Charging the battery is possible, for example, by means of a charging station that can be provided at the individual parking stall for the cart.

Alternatively, for example, the energy requirements of the shopping cart 1 can be met by means of a hub dynamo on at least one of the wheels 4 of the shopping cart 1.

Numerous other possibilities for supplying the cart 1 with energy are conceivable and are left up to the person skilled in the art.

### LIST OF REFERENCE SIGNS

1 Shopping cart
2 Antenna
2.1 Transmitting antenna
2.2 Receiving antenna
2a Antenna system
3 Chassis
4 Wheel
5 Basket
5.1 Basket wall, side
5.2 Basket wall, side
5.3 Basket wall, front
5.4 Flap
5.5 Basket base
5.6 Child seat
5.7 Partition wall
6 Recess
7 Controller
8 Inductor, condenser
9 Fixing means
10 Covering device
11 Coupling
12 Feed cable
13 Processing unit
14 Display device, display
15 Pushing device
16 Structure

1. A stackable shopping cart with a chassis with wheels and a pushing device and a basket, whereby the basket is formed of various parts, such as the basket sides, and a basket base, a flap, whereby the components of the basket are manufactured predominantly of plastic, and whereby the shopping cart is provided with an antenna, wherein each cart features an antenna system with a plurality of antennas, whereby each antenna is configured as a transmitting antenna or a receiving antenna, and whereby each antenna is enclosed, completely and/or partially by components to of the basket.

2. A stackable shopping cart according to claim 1, wherein the antenna system features at least two antennas with one or more couplings, a controller, and in each case a cable between the controller and the antennas.

3. A stackable shopping cart according to claim 1, wherein the individual components of the basket features a recess.

4. A method of manufacturing a stackable shopping cart with a chassis with wheels and a pushing device and a basket, in which the basket is formed of various parts, such as the basket walls and a basket base, a flap, in which the parts of the basket are manufactured predominantly of plastic, and in which the shopping cart is provided with an antenna, characterized in that at least the parts of the basket are provided with a recess during the injection molding process.

5. A method of manufacturing a stackable shopping cart with a chassis with wheels and a pushing device and a basket, in which the basket is formed of various parts, such as the basket walls and a basket base, a flap, whereby the parts of the basket are manufactured predominantly of plastic, and whereby the shopping cart is equipped with an antenna, characterized in that each antenna is enclosed, completely and/or partially, during the injection molding process of the parts of the basket.

6. A method of reading out the RFID tags of the merchandise inside a stackable shopping cart, wherein only one transmitting antenna is in operation, and that the transmitting power of the antenna that is in operation is raised by single steps.

7. A stackable shopping cart according to claim 2, wherein the individual components of the basket features a recess.
